(19) United States
(12) Patent Application Publication
(10) Pub. No.: US 2022/0032515 A1
(43) Pub. Date: Feb. 3, 2022

(54) METHOD FOR PRODUCING A METAL-PLASTIC COMPOSITE PART, AND METAL-PLASTIC COMPOSITE PART

(71) Applicant: Hella GmbH & Co. KGaA, Lippstadt (DE)

(72) Inventors: Frank BRINKMEIER, Lippstadt (DE); Michael LAKENBRINK, Oelde (DE); Jan Daniel WENZEL, Hamm (DE); Thomas WIESE, Lippstadt (DE)

(73) Assignee: Hella GmbH & Co. KGaA, Lippstadt (DE)

(21) Appl. No.: 17/499,468

(22) Filed: Oct. 12, 2021

Related U.S. Application Data
(63) Continuation of application No. PCT/EP2020/057758, filed on Mar. 20, 2020.

(30) Foreign Application Priority Data
Apr. 12, 2019 (DE) 10 2019 109 759.2

(51) Int. Cl. B29C 45/14; B32B 3/30; B32B 15/08

(52) U.S. Cl. CPC B29C 45/14311; B32B 3/30; B29K 2705/00; B29C 2045/1495; B32B 15/08

(57) ABSTRACT

A method for producing a metal-plastic composite part having a plastic component and a metal component. A microstructure is produced in a contact face of the metal component, wherein the microstructure has undercuts in relation to the contact face. The metal component is arranged in an injection mold such that the plastic material of the plastic component can be injection molded over the contact face of the metal component. The plastic component is injection molded, wherein some of the liquid plastic material penetrates into the undercuts of the microstructure or encloses the same. The plastic material of the plastic component is cooled to form an interlocking and/or friction connection between the plastic component and the metal component.

This nonprovisional application is a continuation of International Application No. PCT/EP2020/057758, which was filed on Mar. 20, 2020, and which claims priority to German Patent Application No. 10 2019 109 759.2, which was filed in Germany on Apr. 12, 2019, and which are both herein incorporated by reference.

### BACKGROUND OF THE INVENTION

### Field of the Invention

The present invention relates to a method for producing a metal-plastic composite part having a plastic component and a metal component. The invention is directed further to a metal-plastic composite part of this type.

### Description of the Background Art

A joint between an optically active plastic component and a metal component is known from DE 10 2014 109 114 A1, which corresponds to U.S. Pat. No. 10,145,530, which is incorporated herein by reference. In order to connect the plastic component to the metal component, a snap hook is shown by way of example on a first side and a screw element on an opposite second side. The example illustrates that connections between plastic components and metal components in the construction of lighting devices for vehicles are usually complex and require several additional components, wherein adhesive connections or clamping connections are used as an alternative when avoiding geometric interlocking connections such as snap hooks and the like and/or when avoiding screw elements. The use of retaining elements such as springs and the like are also common.

The conventional art, however, disadvantageously results in a complex design and assembly of the joint connection, and multiple additional components or additional materials such as screws, springs, or adhesives and the like are typically necessary.

A further disadvantage arises when, for example, in the case of a screw connection or rivet connection, a point-wise force-transferring connection is produced, which occurs when the joint is subjected to mechanical stress. The connection is highly stressed and the material in some cases, therefore, the plastic or the metal, can experience high local stresses in the connection area. This results in unwanted deformations, which are to be avoided in particular with tight tolerances; this also applies with regard to the position and arrangement of optically active components, such as bulb carriers, reflectors, lenses, light guides, and the like.

A method for producing a joint connection is known from DE 10 2017 214 518 A1, in which a cast component is connected to a metallic structural element. The metallic structural element must be produced generatively, for example, by powder bed processes, by selective laser sintering, or selective laser melting. The surface of the metallic structural element has a surface structure which comprises micro-depressions into which the casting material of the cast component can penetrate. This creates an interlocking, planar micro-connection between the metallic structural element and the cast component. Disadvantageously, the applicability of the connection technology presented is transferable only to a limited extent, because not every metallic structural element can be produced in the generative process; in particular not for reasons of cost and, moreover, a more extensive application of the method is not known without forming an interlocking connection between the structural element and the cast component. Here the joining components are positively interlocked.

A method for producing reflectors is known from EP 2 589 479 A2, in particular high-precision and dimensionally stable reflectors for a vehicle headlight, wherein the following steps are provided: producing a metallic, preferably one-piece body, which body formed of a base body and at least one reflector shell, and applying a plastic material to form the at least one reflector surface in the optically active region of the at least one reflector shell, wherein the at least one reflector shell is coated or reshaped with the material. Disadvantageously, a substantially complete coating of the base body with the plastic material is necessary in this case in order to prevent detachment of the plastic material from the base body, wherein the base body is made, for example, from a metal material.

DE 10 2012 011 635 A1 discloses a lamp comprising a circuit board on which at least one bulb is disposed, as well as a reflector unit with a reflector body which is secured by a reflector holder above the bulb on a circuit board supporting the bulb, wherein the reflector body is formed with an end face section facing the circuit board on a retaining section of the reflector holder, which is inhomogeneous in terms of material with respect to the reflector body, and the reflector holder is soldered to the circuit board with a soldering section made of metal material and located outside the reflector body. It is provided here that the reflector holder with a retaining section is inserted into a casting or injection mold, for example, such that the retaining section forms part of the wall of the casting mold or rests against it, so that when the reflector material is introduced, the retaining section of the reflector holder is integrally molded onto the reflector body or molded into it. A material bond or a bond similar to a material bond arises directly between the retaining section and the material of the reflector body, for example, by atomic or molecular bonds between the materials and/or by micro-interlocking in the sense of a microscopic or macroscopic hooking of the inflowing reflector material onto or into the surface structure and any pores and roughness that may be present there, so that the reflector material binds to the retaining section of the reflector holder during solidification. Similar to what is known in two-component injection molding, the retaining section of the reflector holder can be bonded directly to the material of the reflector body. Disadvantageously, the joint strength depends on the surface properties of the metal component forming the reflector holder, and no defined joint strength between the metal component and the plastic component can be assumed.

### SUMMARY OF THE INVENTION

It is therefore an object of the present invention to provide a method for producing a metal-plastic composite part, in particular for a lighting device of a vehicle. The method is intended to produce the plastic component by injection molding. In particular, the adhesion between the plastic component and the metal component is to be increased significantly and the possibility is to be created of locally varying the adhesion over the entire contact face between the plastic component and the metal component.

The method of the invention for producing a metal-plastic composite part having a plastic component and a metal component provides the following steps according to the invention: producing a microstructure in a contact face of the metal component, wherein the microstructure has undercuts in relation to the contact face; laying the metal component in an injection mold such that the plastic material of the plastic component can be injection molded over the contact face of the metal component; injection molding the plastic component, wherein some of the liquid plastic material penetrates into the undercuts of the microstructure or encloses same; and cooling the plastic material of the plastic component to form an interlocking and/or friction connection between the plastic component and the metal component.

The inventive implementation of the method for producing a metal-plastic composite part begins with the idea of creating a particularly geometrically defined microstructure on the contact face with which a micro-interlocking is achieved between the metal component and the plastic component, which enables a defined high joint strength. By injection molding the plastic component, the plastic can hook into the microstructure, in particular due to the undercuts, and thereby form a micro-interlocking.

If the method of the invention is used to provide a metal-plastic composite part for a structure in a lighting device of a vehicle, the generally sensitive and optically active plastic components, to be positioned precisely, such as lenses, light guides, thick-wall optics, reflectors, bulb carriers, and the like, can be easily mounted on a metal component and produced in conjunction with it, and no additional elements such as screws, clamping elements, or springs are required. In addition, no joining materials such as adhesives or the like are necessary.

The joint connections in the lighting device, for example, in the assembly of light modules in a headlight, have improved properties; in particular the securing of solid optically active components such as thick-wall light guides can be constructed in an improved manner using the attached metallic components as holding elements. Optically transparent materials such as PMMA or certain types of PC plastic have a high brittleness, which very often leads to considerable problems with the load-resistant fastening of the components. The advantage of the joint connection of the invention lies in the planar connection without the creation of punctiform joint connections such as, for example, with a screw connection, so that no stress peaks arise in the sensitive optically active component.

The particular advantage that can be used with the method of the invention is that the penetration of some of the liquid plastic material into the undercuts of the microstructure can be produced with an injection pressure of the liquid plastic material in the injection molding process itself. No further press device is therefore required in order to introduce the plastic material into the undercuts in the microstructure.

With further advantage, the metal component is heated before it is inserted into the injection mold so that the plastic material can better penetrate into the undercuts in the microstructure.

For this purpose, the introduction of heat for heating the metal component can be achieved by means of contact heating elements, by means of laser irradiation, or by means of IR irradiation of the complementary joint face of the plastic component. Furthermore, heat can also be introduced by induction or oven storage or by other suitable methods. By heating the metal component, the enclosing of the undercuts of the microstructure is promoted, because then the plastic melt in the injection molding does not also cool down on a cold surface of the metal component and loses its flowability.

For example, the microstructure has furrows or notches in the surface of the metal component, which running obliquely with respect to the surface into the body of the metal component. The angle of inclination of the grooves or openings in the metal component can be varied alternately, so that the plastic component cannot be detached again from the metal component in a pull-out direction. In addition, it is possible to execute the microstructure itself with undercuts, for example, by means of increasing lateral dimensions of a microstructure at a greater depth within the metal component. Such microstructures can be produced, for example, by laser ablation or by means of an etching process. The geometric dimensions of the microstructures can be, for example, 10 μm to 1000 μm.

The microstructure in the joint face of the metal component can have depressions or elevations. If the microstructure is made raised in the joint face, then the plastic encloses it in the injection molding process, so that an interlocking connection and/or a friction connection is formed after the plastic has cooled down.

If material tongues form within the microstructure, which in particular also run obliquely to the surface and are aligned in different oblique directions distributed over the joint face, an interlocking connection is created between the plastic component and the metal component. In addition, a friction connection can be formed, in particular due to slight shrinkage processes when the plastic material cools, in particular in the area of the material tongues. As a result, the plastic component digs into the surface of the metal component to a certain extent. The connection is thus established permanently. Such a joint connection can advantageously be used for optics that are applied to holders or the like, or metal components can in turn be applied to the optic itself, for example, if these have larger dimensions.

With a further advantage, the joint face with the microstructure is selected to be the same size or smaller than a contact face between the plastic component and the metal component. In this way, surface sections with a force transfer between the plastic component and the metal component can be created in a targeted manner; these can be configured in such a way that only low mechanical loads arise in the joining zones, so that the actual contact face between the components can be considerably larger than the joint face. Through the only local use of the connection, contact regions between the plastic component and the metal component can be created in a targeted manner; these regions are arranged in such a way that an ideal force transfer between the plastic component and the metal component is achieved. The joint face is chosen to be so large that the specific surface load during the force transfer remains clearly below a damage limit.

In addition, it is advantageous that an isolated or multiple individually separately formed joint faces with the microstructure are formed on a contact face between the plastic component and the metal component. For example, in the case of a rectangular contact face between an optic and a metallic carrier body, joint faces can be provided in the four corners of the rectangular shape.

With a further advantage, the metal component is formed by means of a Mg alloy, an AL alloy, a Zn alloy, or an Fe alloy and/or the metal component is produced by means of a die casting process, an extrusion process, a forging process, by means of machining, and/or by means of a stamping-bending process.

The joint face with the microstructure between the plastic component and the metal component is advantageously chosen so that, despite the different thermal expansion coefficients between the plastic component and the metal component, when the component is heated, there is no or only a reduced deformation of the geometry of the metal-plastic composite part as a reflector, as a light guide body, as thick-wall optics, or as primary optics or as some other optically active component, or when heated, no or only a reduced change in the position of the metal-plastic composite part relative to the installation environment is achieved in that the metal component has a high thermal conductivity and lower thermal expansion compared to the plastic component.

In order to further improve the adhesion between the metal component and the plastic component, an adhesion promoter can be applied to the contact face of the metal component before the injection molding.

The invention is directed further to a metal-plastic composite part, produced by a method according to the above description, wherein the metal-plastic composite part forms an optically active component of a lighting device of a vehicle. In particular, the metal-plastic composite part forms a reflector of a lighting device of a vehicle. The metal component in particular forms a base structure of the reflector and the plastic component has a reflective layer on a surface facing a bulb. To ensure the durability of the composite part, the plastic component has a plastic material with a mineral filler component, particularly in the case of reflectors.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a schematic cross-sectional view through the composite between the plastic component and the metal component; and

FIG. 2 shows a view of a reflector as an example of a metal-plastic composite part with an optically active plastic component and a metal component.

### DETAILED DESCRIPTION

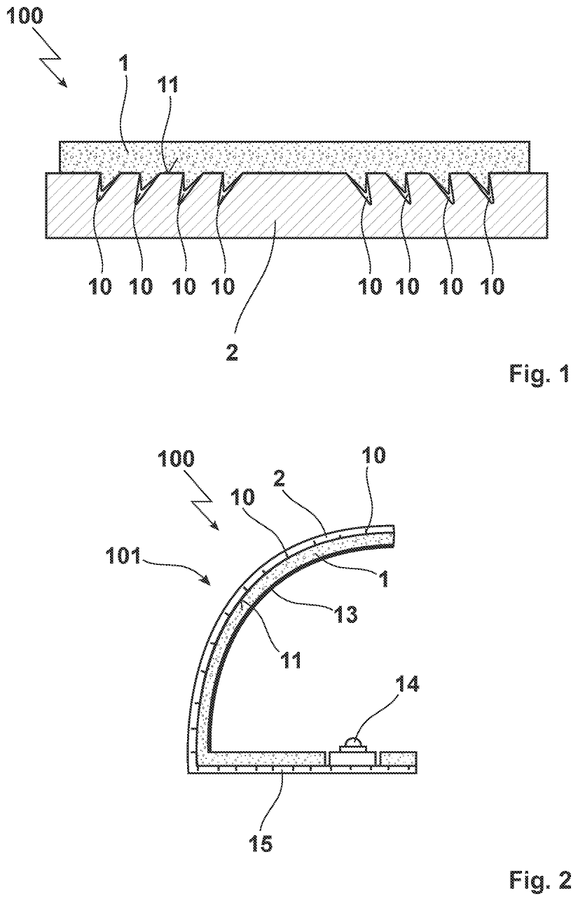

FIG. 1 shows a cross-sectional view through a composite between a plastic component 1 and a metal component 2, so that the composite forms a metal-plastic composite part 100. Plastic component 1 and metal component 2 are shown in abstract form and are therefore designed to be optically active in a manner not shown in more detail, and plastic component 1 relates, for example, to a reflective or transmissive optic of a light module in a lighting device of a vehicle, for example, a reflector.

Metal component 2 can be, for example, a holder, a screen, or some other structural part of the reflective or transmissive optic, for instance, a base body of the reflector, a heat sink, or sections of the same components.

Microstructures 10 which, starting from the surface, run obliquely into the body of metal component 2, are introduced into the surface of metal component 2, said surface serving as contact face 1 to plastic component 1, wherein the angles of inclination of microstructures 10 point in directions differing from one another, shown schematically in the view with the left-hand microstructures 10 with the oppositely oriented right-hand microstructures 10. Alternatively, contact face 11 can be formed with microstructures 10 that are raised above contact face 11, therefore extend into plastic component 1 in conjunction therewith. Undercuts or geometrically designed interlocking connections are also conceivable with this.

Microstructures 10 have been introduced into metal component 2, for example, using a laser ablation method or using an etching method or another suitable method. The diagram of microstructure 10 is oversized with respect to the thickness of metal component 2, and it is sufficient if microstructure 10 merges into the material with a depth of, for example, less than 1000 μm, less than 500 μm, or less than 200 μm in depth starting from the surface. The microstructure can also be formed protruding from the metal component.

To produce the composite, microstructure 10 is first produced in contact face 11 of metal component 2, wherein microstructure 10 has undercuts in relation to contact face 11. Next, metal component 2 is placed in an injection mold such that the plastic material of plastic component 1 can be injection molded over contact face 11 of metal component 2. Finally, the injection molding of plastic component 1 follows, wherein some of the liquid plastic material penetrates into the undercuts of microstructure 10 or encloses same, as shown in FIG. 1. Cooling the plastic material of plastic component 1 then follows to form an interlocking and/or friction connection between plastic component 1 and metal component 2.

FIG. 2 shows a metal-plastic composite part 100 in the form of a reflector 101, as can be used, for example, in a lighting device of a vehicle. Reflector 101 has a base body, which is formed with metal component 2, and in a region of reflector 101 into which a bulb 14 can shine, and for the purpose of stiffening the reflector body and for the purpose of producing an anti-reflective surface in the region of a reflector base 15, metal component 2 has, for example, the molded plastic component 1 in the regions mentioned. In particular, the free surface of plastic component 1 can be produced with a very low surface roughness, to which finally a reflective layer 13 is applied, which fulfills the actual reflector function of the light generated by bulb 14.

Contact face 11 of metal component 2 is provided with microstructure 10 onto which plastic component 1 is injection molded.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing a metal-plastic composite part having a plastic component and a metal component, the method comprising:
producing a microstructure in a contact face of the metal component, wherein the microstructure has undercuts in relation to the contact face;
laying the metal component in an injection mold such that the plastic material of the plastic component is injection molded over the contact face of the metal component;
injection molding the plastic component, wherein some of the liquid plastic material penetrates into the undercuts of the microstructure or encloses same; and
cooling the plastic material of the plastic component to form an interlocking and/or friction connection between the plastic component and the metal component.

2. The method according to claim 1, wherein a penetration of some of the liquid plastic material into the undercuts of the microstructure is produced with an injection pressure of the liquid plastic material in the injection molding process.

3. The method according to claim 1, wherein the microstructure in the metal component is produced by laser ablation or by an etching process or by another suitable process or in that the microstructure is formed by elevations on the contact face of the metal component.

4. The method according to claim 1, wherein a joint face with the microstructure is the same size or smaller than a contact face between the plastic component and the metal component.

5. The method according to claim 4, wherein an isolated or multiple individually separately formed joint faces with the microstructure are formed on a contact face between the plastic component and the metal component.

6. The method according to claim 1, wherein the metal component is formed by a Mg alloy, an AL alloy, a Zn alloy, or an Fe alloy and/or is produced by a die casting process, an extrusion process, a forging process, machining, and/or by a stamping-bending process.

7. The method according to claim 1, wherein the joint face with the microstructure between the plastic component and the metal component is chosen so that, despite the different thermal expansion coefficients between the plastic component and the metal component, when the component is heated, there is no or only a reduced deformation of the geometry of the metal-plastic composite part as a reflector, as a light guide body, as thick-wall optics, or as primary optics or as some other optically active component, or when heated, no or only a reduced change in the position of the metal-plastic composite part relative to the installation environment is achieved in that the metal component has a high thermal conductivity and lower thermal expansion compared to the plastic component.

8. The method according to claim 1, wherein an adhesion promoter is applied to the contact face of the metal component before the injection molding of the plastic component.

9. A metal-plastic composite part produced according to the method according to claim 1, wherein the metal-plastic composite part forms an optically active component of a lighting device of a vehicle.

10. The metal-plastic composite part according to claim 9, wherein the metal-plastic composite part forms a reflector of a lighting device of a vehicle.

11. The metal-plastic composite part according to claim 10, wherein the metal component forms a base structure of the reflector and wherein the plastic component has a reflective layer on a surface facing a light source.

12. The metal-plastic composite part according to claim 9, wherein the plastic component has a plastic material with a mineral filler component.
